(19) United States
(12) Patent Application Publication
(10) Pub. No.: US 2017/0045739 A1
(43) Pub. Date: Feb. 16, 2017

(54) TRANSMISSION-TYPE SCREEN AND HEADUP DISPLAY

(71) Applicant: SHARP KABUSHIKI KAISHA, Sakai City, Osaka (JP)

(72) Inventors: Naru USUKURA, Sakai City (JP); Hiromi KATOH, Sakai City (JP); Takafumi SHIMATANI, Sakai City (JP)

(21) Appl. No.: 15/305,391

(22) PCT Filed: Apr. 20, 2015
(86) PCT No.: PCT/JP2015/061949

§ 371 Date: Oct. 20, 2016

(30) Foreign Application Priority Data
Apr. 21, 2014 (JP) 2014-087488

(51) Int. Cl. G02B 27/01; B60K 35/00; G02B 27/48

(52) U.S. Cl. CPC G02B 27/0101; G02B 27/48; B60K 35/00; G02B 2027/0141; G02B 2027/0123; B60K 2350/1072; B60K 2350/203; B60K 2350/2047; B60K 2350/2056; B60K 2350/2095

(57) ABSTRACT

A transmission screen (2) includes at least two optical elements (13 and 14) condensing or diverging a light beam anisotropically. The at least two optical elements each include a light receiving surface (10) receiving display light; and a light emitting surface (11) emitting a divergent light beam toward a combiner (4).

### TECHNICAL FIELD

The present application relates to a transmission screen, and specifically to a transmission screen usable for a headup display.

### BACKGROUND ART

A headup display (hereinafter, referred to as an “HUD”) displays information within a field of view of a human is used to display information on a windshield of a vehicle such as an airplane, an automobile or the like to assist steering or driving.

A structure of an HUD will be described briefly. FIG. 12 shows a structure of a conventionally typical HUD. The HUD typically includes a video source, a transmission screen, and a combiner. One method for operating the HUD uses a virtual image system. According to this method, a light beam output from the video source is condensed by the transmission screen, which is a transparent body (e.g., formed of glass), and thus a real image is formed (displayed). The transmission screen acts as a secondary light source, and outputs the condensed light beam toward the combiner. The combiner has a function of displaying a video image formed on the transmission screen in an enlarged state at a far position, and also has a function of displaying the video image as overlapping scenery. The combiner forms a virtual image based on the light beam directed toward the combiner. This allows a pilot or a driver to check the video image together with the scenery through the combiner.

Patent Document 1 discloses an HUD including a transmission screen that includes first and second microlens arrays (hereinafter, referred to as “MLAs”) each including an array of a plurality of microlenses. As shown in FIG. 3 of Patent Document 1, the transmission screen includes the first and second MLAs facing each other. A pitch of adjacent microlenses in the first MLA is different from that in the second MLA. The MLAs are configured such that the pitch in the second MLA is larger than the pitch in the first MLA. The transmission screen is designed such that light transmitted through the plurality of microlenses in the first MLA is condensed by a single microlens in the second MLA.

The light condensed by the plurality of microlenses in the first MLA is incident on a single microlens in the second MLA. A plurality of pixels formed by the first MLA are assembled by the second MLA into a pixel having a diameter larger than a sum of diameters of the plurality of pixels. In this state, bright spots in the pixels are not conspicuous. The HUD described in Patent Document 1 suppresses generation of excessively bright spots in the pixels (luminance non-uniformity).

### CITATION LIST

### Patent Literature

Patent Document 1: Japanese Patent No. 4954346

### SUMMARY OF INVENTION

### Technical Problem

However, according to the studies made by the present inventors, the transmission screen disclosed in Patent Document 1 has a problem that the distribution of the luminous intensity of the light beam output from the transmission screen toward the combiner is not sufficiently controlled, and thus the light utilization factor is declined.

From the point of view of decreasing power consumption, it is preferable that with the above-described method for operating the HUD, an irradiation region of the light beam on the combiner is sufficiently restricted in consideration of the range in which the driver or the like is capable of viewing a video image regarding the information (in consideration of a viewing area). The “viewing area” is generally referred to also as an “eye box”.

With the structure of the microlenses disclosed in Patent Document 1, the light beam transmitted through the two MLAs is diverged in a circular manner, and the range of divergence is, for example, a circle centered around the center of the combiner as shown in FIG. 12. From the point of view of improving the light utilization factor, it is sufficient that the light beam irradiates a planar area of the combiner. However, with the structure disclosed in Patent Document 1, the light beam also irradiates an area other than the planar area of the combiner and does not irradiate only the planar area of the combiner efficiently. In this case, the light beam that is to irradiate the combiner is significantly wasted.

For this reason, with the prior art, it is difficult to output a light beam in alignment with the viewing area, which declines the light utilization factor. Thus, it is difficult to realize low power consumption.

Human eyes are located in a lateral direction. Therefore, the field of view of a human is larger in the lateral direction than in a vertical direction. Therefore, the viewing area is required to be large in the lateral direction, but may be smaller in the vertical direction than in the lateral direction. Thus, it is effective to configure a transmission screen such that the light beam directed toward the combiner in a rectangular or elliptical shape in consideration of the viewing area.

In the case where a laser light source is used as a video source, light beams transmitted through the MLA interfere with each other, and as a result, speckles are generated in the irradiation region of the light beam. The speckles are visually recognized as bright/dark patterns by the driver or the like, and thus significantly decline the display quality.

An object of the present invention is to control the distribution of the luminous intensity of a light beam output from a transmission screen toward a combiner to improve the light utilization factor. Another object of the present invention is to suppress the generation of a speckle.

### Solution to Problem

A transmission screen in an embodiment according to the present invention includes at least two optical elements condensing or diverging a light beam anisotropically. The at least two optical elements include a light receiving surface receiving display light; and a light emitting surface emitting a divergent light beam toward a combiner. The divergent light beam forms, on the combiner, a generally rectangular or elliptical irradiation region in correspondence with the cross-sectional shape thereof.

In an embodiment, the at least two optical elements condense or diverge the light beam in a monoaxial direction or biaxial directions.

In an embodiment, the at least two optical elements include a lenticular lens.

In an embodiment, the at least two optical elements include a first lenticular lens including a plurality of hemicylindrical lenses arranged in a first direction and a second lenticular lens including a plurality of hemicylindrical lenses arranged in a second direction crossing the first direction; and a lens surface of the first lenticular lens is directed toward the light emitting surface, and a lens surface of the second lenticular lens is directed toward the light receiving surface to face the lens surface of the first lenticular lens.

In an embodiment, the at least two optical elements include a first lenticular lens including a plurality of hemicylindrical lenses arranged in a first direction and a second lenticular lens including a plurality of hemicylindrical lenses arranged in a second direction crossing the first direction; and a lens surface of the first lenticular lens and a lens surface of the second lenticular lens are directed in the same direction as each other toward the light receiving surface or the light emitting surface.

In an embodiment, the first direction and the second direction are perpendicular to each other.

In an embodiment, the first lenticular lens is located on the side of the light receiving surface of the second lenticular lens; and the lens surface of the first lenticular lens and the lens surface of the second lenticular lens are convexed, and a focal length of the first lenticular lens is longer than a focal length of the second lenticular lens.

In an embodiment, the first lenticular lens is located on the side of the light receiving surface of the second lenticular lens; and the lens surface of the first lenticular lens and the lens surface of the second lenticular lens are concaved, and a focal length of the first lenticular lens is shorter than a focal length of the second lenticular lens.

In an embodiment, the first lenticular lens and the second lenticular lens are integrally formed.

In an embodiment, the at least two optical elements further include a microlens array including an array of a plurality of microlenses. It is preferable that in the microlens array, the plurality of hexagonal microlenses are located in a hexagonal close-packed arrangement.

In an embodiment, the at least two optical elements further include a microlens array including an array of a plurality of microlenses; and the microlens array is located on the side of the light receiving surfaces of the first and second lenticular lenses. It is preferable that in the microlens array, the plurality of hexagonal microlenses are located in a hexagonal close-packed arrangement.

In an embodiment, the at least two optical elements further include a microlens array including an array of a plurality of microlenses; and the microlens array is located on the side of the light receiving surface of the first lenticular lens. It is preferable that in the microlens array, the plurality of hexagonal microlenses are located in a hexagonal close-packed arrangement.

In an embodiment, the at least two optical elements further include a microlens array including an array of a plurality of microlenses; and the microlens array is located on the side of the light emitting surface of the second lenticular lens. It is preferable that in the microlens array, the plurality of hexagonal microlenses are located in a hexagonal close-packed arrangement.

In an embodiment, directions of a plurality of vectors each representing a shift direction between adjacent microlenses in the microlens array are different from each other.

In an embodiment, each of the directions of the plurality of vectors and a direction of a vector representing a shift direction between adjacent lenses in the lenticular lens are different from each other.

In an embodiment, the at least two optical elements include any one of a light diffuser plate, a fiber optical plate in which a plurality of optical fibers are arranged, a volume or embossed hologram element, and a diffraction grating. It is preferable that in the fiber optical plate, the plurality of hexagonal optical fibers are located in a hexagonal close-packed arrangement.

In an embodiment, a headup display includes a video source outputting display light; the above-described transmission screen; and a combiner.

In an embodiment, the video source is a laser light source.

### Advantageous Effects of Invention

An embodiment of the present invention provides a transmission screen controlling the distribution of the luminous intensity of a light beam output from the transmission screen toward a combiner to improve the light utilization factor, and a headup display including such a transmission screen.

### BRIEF DESCRIPTION OF DRAWINGS

FIG. 1(a) is a schematic view of a headup display 100 in embodiment 1 according to the present invention as seen at a certain angle, and FIG. 1(b) is a schematic view of the headup display 100 as seen at another angle.

FIG. 2 shows examples of optical element, condensing or diverging a light beam anisotropically, that may be located in a transmission screen 2.

FIG. 3(a) and FIG. 3(e) are each a schematic cross-sectional view showing a structure of the transmission screen 2; FIG. 3(b) and FIG. 3(c) each show a shape of a lenticular lens 13 as seen from the side of a light emitting surface 11 of the transmission screen 2 and a shape of a lenticular lens 14 as seen from the side of a light receiving surface 10 of the transmission screen 2; and FIG. 3(d) is a schematic view showing the relationship between focal lengths of the lenticular lenses 13 and 14.

FIG. 4(a) and FIG. 4(d) are each a schematic cross-sectional view showing a structure of a transmission screen 2A; FIG. 4(b) is a schematic view showing a shape of a lenticular lens 21 as seen from the side of the light receiving surface 10 of the transmission screen 2A shown in FIG. 4(a); and FIG. 4(c) is a schematic view showing a shape of the lenticular lens 21 as seen from the side of the light emitting surface 11 of the transmission screen 2A shown in FIG. 4(d).

FIG. 5(a) is a schematic cross-sectional view showing a structure of a transmission screen 2B; and FIG. 5(b) and FIG. 5(c) are each a schematic view showing a shape of an MLA 12 as seen from the side of the light emitting surface 11 of the transmission screen 2B, a shape of the lenticular lens 13 as seen from the side of the light receiving surface 10 of the transmission screen 2B, and a shape of the lenticular lens 14 as seen from the side of the light emitting surface 11.

FIG. 6(a) and FIG. 6(c) are each a schematic cross-sectional view showing a structure of a transmission screen 2C; and FIG. 6(b) is a schematic view showing a shape of the MLA 12 as seen from the side of the light receiving surface 10 of the transmission screen 2C shown in FIG. 6(a) and a shape of the lenticular lens 21 as seen from the side of the light emitting surface 11 of the transmission screen 2C shown in FIG. 6(a).

FIG. 7(a) is a schematic cross-sectional view showing a structure of a transmission screen 2D; and FIG. 7(b) and FIG. 7(c) are each a schematic view showing a shape of a fiber optical plate 20 as seen from the side of the light emitting surface 11 of the transmission screen 2D, a shape of the lenticular lens 13 as seen from the side of the light receiving surface 10 of the transmission screen 2D, and a shape of the lenticular lens 14 as seen from the side of the light emitting surface 11.

FIG. 8(a) is a schematic cross-sectional view showing a structure of a transmission screen 2E; and FIG. 8(b) and FIG. 8(c) are each a schematic view showing a shape of the lenticular lens 21 as seen from the side of the light emitting surface 11 and as seen from the side of the light receiving surface 10.

FIG. 9(a) is a schematic cross-sectional view showing a structure of a transmission screen 2F; and FIG. 9(b) is a schematic view showing a shape of an MLA 22 of a quadrangular arrangement as seen from the side of the light emitting surface 11 and as seen from the side of the light receiving surface 10.

FIG. 10 is a schematic view of a headup display 200 in embodiment 3 according to the present invention.

FIG. 11(a) is a schematic cross-sectional view showing a structure of a transmission screen 2G; and FIG. 11(b) is a schematic view showing a shape of the MLA 12 as seen from the side of the light emitting surface 11 of the transmission screen 2G and a shape of an MLA 23 of a deformed hexagonal close-packed arrangement as seen from the side of the light receiving surface 10 of the transmission screen 2G.

FIG. 12 is a schematic view showing a conventionally typical headup display.

### DESCRIPTION OF EMBODIMENTS

As a result of accumulating studies, the present inventors conceived combining optical elements (e.g., lenticular lenses) condensing or diverging a light beam anisotropically to arrive at a novel transmission screen directing a divergent light beam toward a combiner in a generally rectangular or elliptical shape.

A transmission screen in an embodiment according to the present invention includes at least two optical elements condensing or diverging a light beam anisotropically. The at least two optical elements include a light receiving surface receiving display light and a light emitting surface emitting a divergent light beam toward a combiner. Such a transmission screen is usable for a headup display to improve the light utilization factor.

Hereinafter, a transmission screen and a headup display including the same in an embodiment according to the present invention will be described with reference to the attached drawings. In the following description, the same or similar components bear the same reference signs. The headup display in an embodiment according to the present invention is not limited to the one described below.

### Embodiment 1

With reference to FIG. 1 through FIG. 3, a structure and a function of a transmission screen 2 and a head display 100 including the same in this embodiment will be described.

FIG. 1(a) is a schematic view of the headup display 100 in this embodiment as seen at a certain angle. FIG. 1(b) is a schematic view of the headup display 100 as seen at another angle.

The headup display 100 includes a video source 1, the transmission screen 2, a field lens 3, and a combiner 4. As described below, the headup display 100 does not need to include the field lens 3.

A light beam output from the video source 1 is condensed by the transmission screen 2 to form a real image. The transmission screen 2 acts as a secondary light source, and outputs the condensed light beam toward the combiner 4 such that the irradiation region 5 on the combiner 4 is generally rectangular. The combiner 4 forms a virtual image based on the light beam directed thereto. This allows a pilot or a driver to check a video image together with scenery through the combiner.

Each of the components in the headup display 100 will be described in detail.

The video source 1 is a device drawing a video image, and is realized by any known component selectable from a wide range. The video source 1 is configured to output display light toward the transmission screen 2. Known methods useable for the drawing include a method using an LCOS (Liquid Crystal On Silicon) or an LCD (Liquid Crystal Display), a method using DLP (Digital Light Processing), a method using a laser projector, and the like.

The method using an LCOS or an LCD mainly uses a three primary color (RGB) LED (Light Emitting diode) light source and an LCOS or an LCD. The method using DLP mainly uses a three primary color (RGB) LED light source and a DMD (Digital Micromirror Device). With these methods, each of the LED light sources irradiates the entirety of the LCD, the LCOS or the DMD with a light beam, and unnecessary light that does not contribute to the video image is cut by the LCD, the LCOS or the DMD.

In the meantime, the method using a laser projector mainly uses a three primary color light source and an MEMS (Micro Electro Mechanical Systems) mirror. With this method, a video image of only a display region as a target is drawn by a raster scan method.

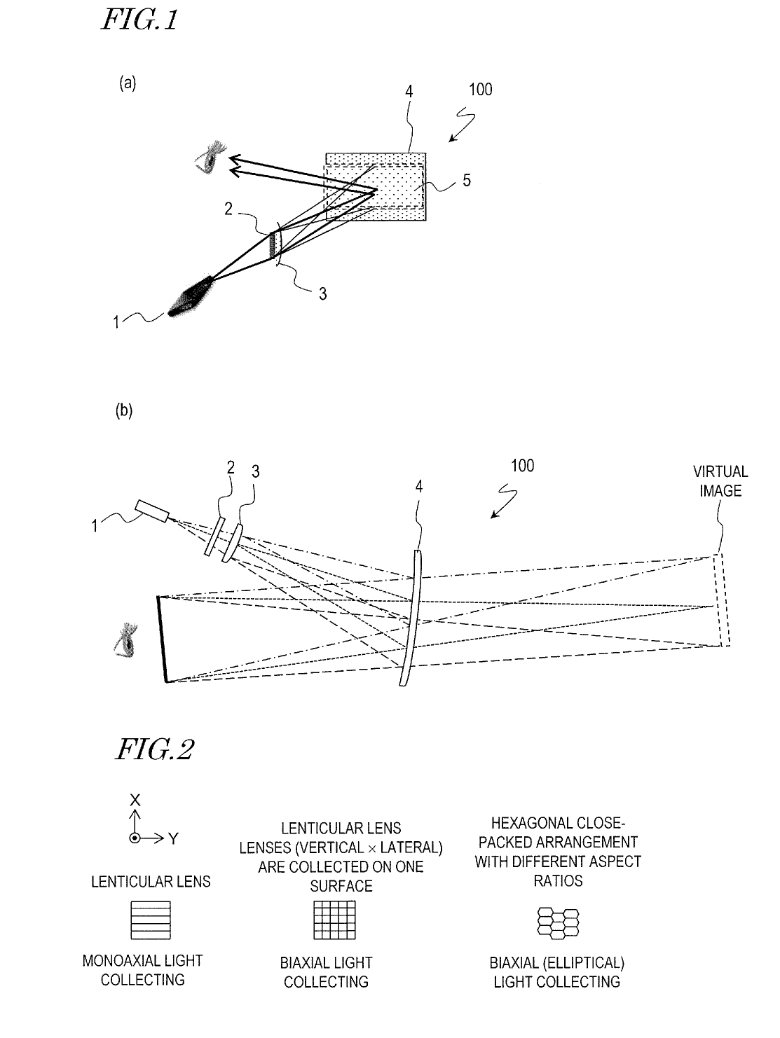

FIG. 2 shows examples of optical element, condensing or diverging a light beam anisotropically, that may be located in the transmission screen 2. An optical element condenses or diverges a light beam in a monoaxial direction or biaxial directions. As shown in FIG. 2, a lenticular lens may be used as an optical element condensing or diverting a light beam in a monoaxial direction (X axis direction in FIG. 2). A lenticular lens having a stack structure may be used as an optical element condensing or diverting a light beam in biaxial directions (X axis direction and Y axis direction in FIG. 2). Also as an optical element condensing or diverting a light beam in biaxial directions, an MLA of a deformed hexagonal close-packed arrangement may be used. These optical elements will be described below in detail.

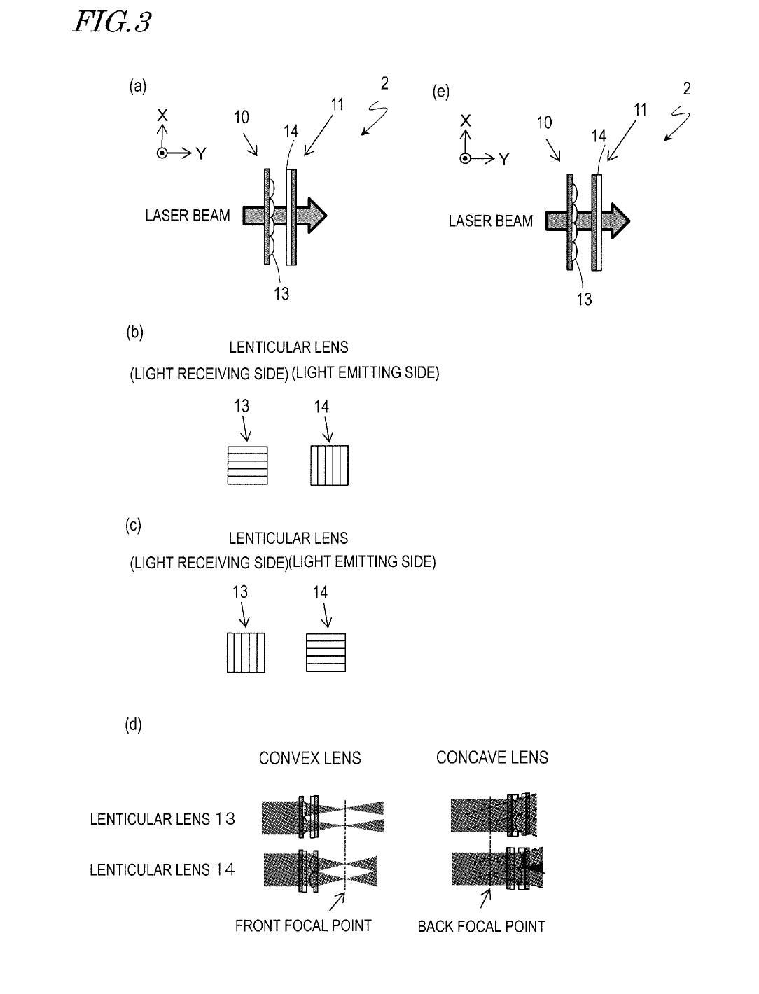

FIG. 3(a) and FIG. 3(e) are each a schematic cross-sectional view showing a structure of the transmission screen 2. FIG. 3(b) and FIG. 3(c) each show a shape of a lenticular lens 13 as seen from the side of a light emitting surface 11 of the transmission screen 2 and a shape of a lenticular lens 14 as seen from the side of a light receiving surface 10 of the transmission screen 2. FIG. 3(d) is a schematic view showing the relationship between focal lengths of the lenticular lenses 13 and 14.

As shown in FIG. 3(a), the transmission screen 2 includes the light receiving surface 10 receiving display light from the video source 1 and the light emitting surface 11 emitting a divergent light beam having a generally rectangular cross-section toward the combiner 4. The expression “generally rectangular cross-section” refers to that the divergent light beam has a generally rectangular cross-section at a plane perpendicular to an optical axis thereof.

In the transmission screen 2, the lenticular lens 13 is located on the side of the light receiving surface 10, and the lenticular lens 14 is located on the side of the light emitting surface 11. A lens surface of the lenticular lens 13 is directed toward the light emitting surface 11, and a lens surface of the lenticular lens 14 is directed toward the light receiving surface 10 to face the lens surface of the lenticular lens 13. In this specification, the “lens surface” refers to a convexed surface or a concaved surface of the lens.

As shown in FIG. 3(e), the lens surfaces of the lenticular lenses 13 and 14 may be directed in the same direction toward the light emitting surface 11. Alternatively, the lens surfaces of the lenticular lenses 13 and 14 may be directed in the same direction toward the light receiving surface 10 (not shown). The transmission screen 2 acts as a secondary light source, and expands the display light from the video source 1 and irradiates the combiner 4 with a divergent light beam. The angle at which the divergent light beam expands is determined based on, for example, the size, the focal length or the like of each of lenses included in the lenticular lens 13 and 14.

The lenticular lens 13 is formed of a plurality of hemicylindrical lenses arrayed in a first direction (X axis direction) in FIG. 3(a). The lenticular lens 14 is formed of a plurality of hemicylindrical lenses arrayed in a second direction (Z axis direction) perpendicular to the first direction. It is preferable that the first array direction and the second array direction are perpendicular to each other from the point of view of providing a generally rectangular cross-section of a divergent light beam to effectively use the light. It should be noted that the first array direction and the second array direction do not need to be perpendicular to each other. For example, these directions may make an angle in the range of 45 degrees to 135 degrees.

As long as the lenticular lenses 13 and 14 are located such that the first array direction and the second array direction cross each other, the first array direction of the lenticular lens 13 and the second array direction of the lenticular lens 14 may be as shown in FIG. 3(c), namely, may be opposite to those shown in FIG. 3(b).

With reference to FIG. 3(d), the relationship between the focal lengths of the lenses included in the lenticular lenses 13 and 14 will be described.

In the case where the lens surfaces of the lenticular lenses 13 and 14 are convexed, the focal length of the lenticular lens 13 is longer than the focal length of the lenticular lens 14. In the case where the lens surfaces of the lenticular lenses 13 and 14 are concaved, the focal length of the lenticular lens 13 is shorter than the focal length of the lenticular lens 14.

In this embodiment, the pitch of adjacent lenses included in the lenticular lenses 13 and 14, the radius of curvature of the lenses, or the first and second array directions may be changed so that the aspect ratio of the shape of irradiation of the divergent light beam having a generally rectangular cross-section (shape of the irradiation region 5) is changed.

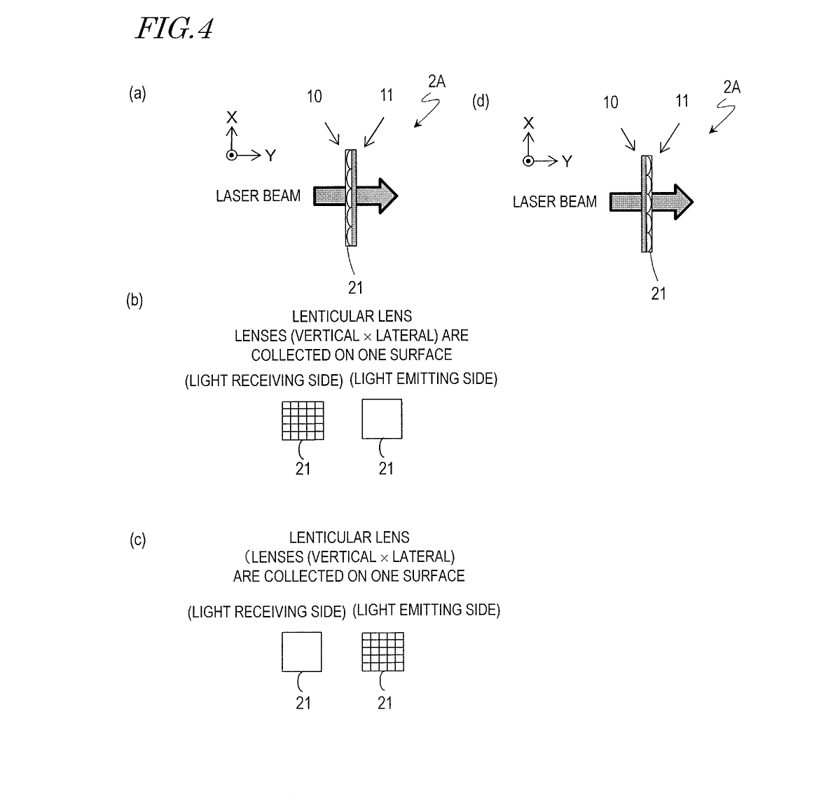

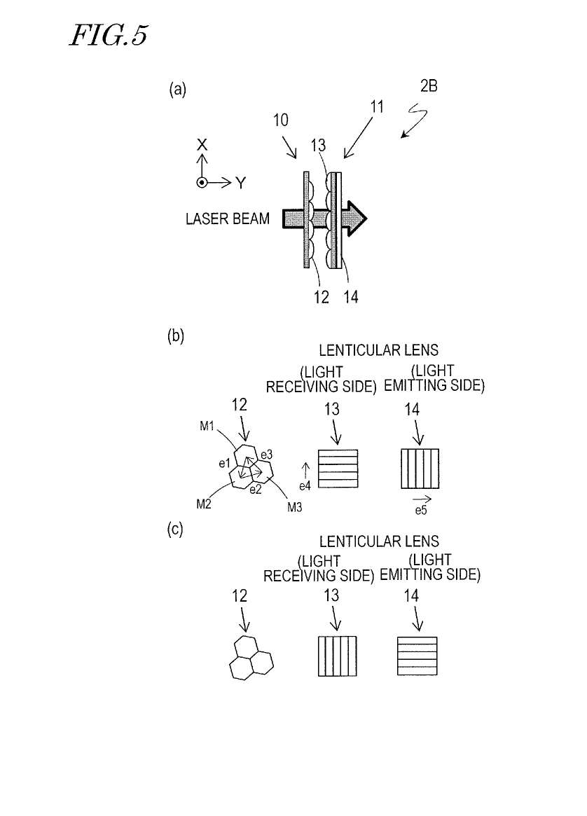

With reference to FIG. 4, a modification of the transmission screen 2 will be described.

FIG. 4(a) and FIG. 4(d) are each a schematic cross-sectional view showing a structure of a transmission screen 2A. FIG. 4(b) shows a shape of a lenticular lens 21 as seen from the side of the light receiving surface 10 of the transmission screen 2A shown in FIG. 4(a). FIG. 4(c) shows a shape of the lenticular lens 21 as seen from the side of the light emitting surface 11 of the transmission screen 2A shown in FIG. 4(d).

The transmission screen 2A includes the lenticular lens 21 having a stack structure. Two lenticular lenses are integrally provided such that lens surfaces thereof are directed toward the light receiving surface 10 of the transmission screen 2A and such that the array directions of the two lenticular lenses cross each other. With such an arrangement, the lenticular lens 21 having a stack structure is formed. It is preferable that the array directions of the lenticular lenses are perpendicular to each other from the point of view of providing a generally rectangular cross-section of a divergent light beam to effectively use the light.

Alternatively, as shown in FIG. 4(c), the two lenticular lenses may be located such that the lens surfaces thereof are directed toward the light emitting surface 11 of the transmission screen 2A and such that the array directions of the two lenticular lenses cross each other. The lenticular lens 21 having a stack structure may be formed with such an arrangement. It is preferable that the array directions of the lenticular lenses are perpendicular to each other from the point of view of providing a generally rectangular cross-section of a divergent light beam to effectively use the light.

In the case where the lenticular lens 21 is provided in the transmission screen 2A, a divergent light beam having a generally rectangular cross-section is output from the light emitting surface 11 of the transmission screen 2A, and the irradiation region 5 of the light is accommodated in the planar area of the combiner 4. This allows the irradiation region of the divergent light beam to be sufficiently restricted to improve the light utilization factor. As a result, low power consumption and/or high luminance of the video image is realized.

Now, FIG. 1 will be referred to again. The field lens 3 is located between the transmission screen 2 and the combiner 4 and at a position close to the transmission screen 2. The field lens 3 is, for example, a convex lens and changes the advancing direction of a light beam that is output from the transmission screen 2. Use of the field lens 3 further improves the light utilization factor. The field lens 3 may be located between the video source 1 and the transmission screen 2 or may not be provided in accordance with the designing specifications or the like.

The combiner 4 is generally, for example, a half mirror, but may be a hologram element or the like. The combiner 4 reflects the divergent light beam from the transmission screen 2 to form a virtual image of the light. The combiner 4 has a function of displaying a video image formed on the transmission screen 2 in an enlarged state at a far position, and also has a function of displaying the video image as overlapping the scenery. This allows the pilot or the driver to check the video image together with the scenery through the combiner. In accordance with the curvature of the combiner 4, the size of the virtual image or the position at which the virtual image is formed may be changed.

In this embodiment, the distribution of the luminous intensity of light of the divergent light beam from the transmission screen 2 may be determined in accordance with the shape of the light emitting surface 11 of the transmission screen 2, and thus the irradiation region 5 of the divergent light beam is accommodated in the planar area of the combiner 4. This allows the irradiation region of the divergent light beam to be sufficiently restricted to improve the light utilization factor. As a result, low power consumption and/or high luminance of the video image is realized.

A general speckle removal measure may be combined with this embodiment to provide an effect of removing a speckle. The general speckle removal measure is, for example, swinging the transmission screen 2, increasing the spectral width of the light source, using a plurality of light sources, or providing scattering light onto an optical path. Instead of such a measure, an MLA or the like may be included in the transmission screen 2 as described below to decrease the number of speckles efficiently. Such a measure decreases the numbers of speckles even in the case where a laser light source is used as the video source 1.

### Embodiment 2

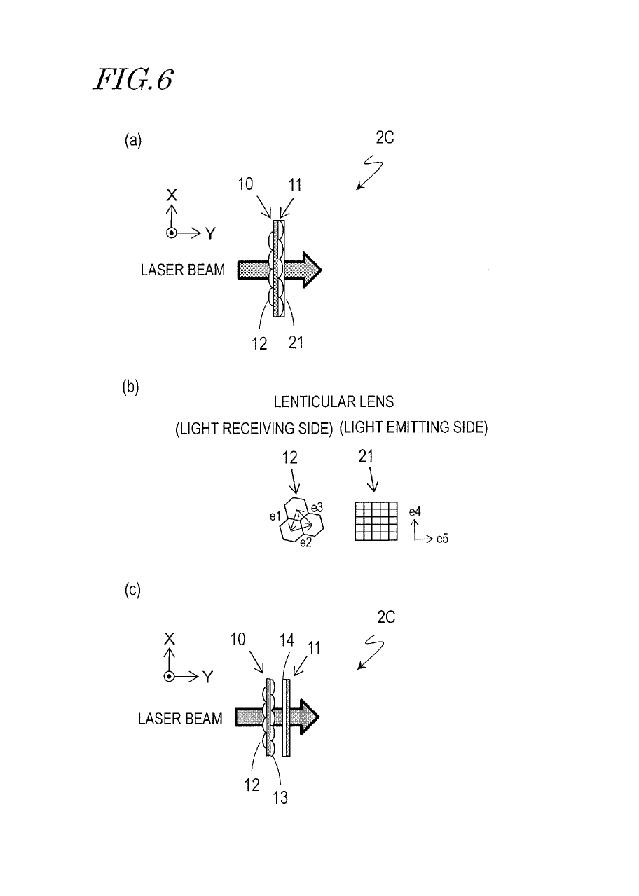

With reference to FIG. 5 and FIG. 6, a structure and a function of a transmission screen in this embodiment will be described. Components same as those of the transmission screen 2 or 2A will bear the same reference signs and the detailed descriptions thereof will be omitted.

A transmission screen 2B in this embodiment includes a lenticular lens and an MLA as optical elements. A lenticular lens is an optical element condensing or diverging a light beam anisotropically, whereas an MLA is an optical element condensing or diverging a light beam isotropically. In this manner, the transmission screen 2B may further include an optical element condensing or diverging a light beam isotropically.

FIG. 5(a) is a schematic cross-sectional view showing a structure of the transmission screen 2B. FIG. 5(b) and FIG. 5(c) each show a shape of an MLA 12 as seen from the side of the light emitting surface 11 of the transmission screen 2B, a shape of the lenticular lens 13 as seen from the side of the light receiving surface 10 of the transmission screen 2B, and a shape of the lenticular lens 14 as seen from the side of the light emitting surface 11.

As shown in FIG. 5(a), the transmission screen 2B includes the light receiving surface 10 receiving display light from the video source 1 and the light emitting surface 11 emitting a divergent light beam having a generally rectangular or elliptical cross-section toward the combiner 4. In the transmission screen 2B, the MLA 12 is located on the side of the light receiving surface, and the two lenticular lenses 13 and 14 are located on the side of the light emitting surface. The transmission screen 2B acts as a secondary light source, and expands the light beam from the video source 1 and irradiates the combiner 4 with the divergent light beam. The angle at which the divergent light beam expands is determined based on, for example, the size, the focal length or the like of each of lenses included in the MLA 12 and the lenticular lens 13 and 14.

As shown in, for example, FIG. 5(b), microlenses included in the MLA 12 are right hexagonal. The MLA 12 is formed of the right hexagonal microlenses arrayed in a hexagonal close-packed arrangement. The lenses in the MLA 12 do not need to be right hexagonal, and may be, for example, rectangular or circular. From the point of view of improving the light utilization factor and decreasing the number of speckles, it is preferable that the lenses are right hexagonal.

A lens surface of the MLA 12 is directed toward the light emitting surface. The MLA 12 condenses display light from the video source 1 to form a real image between the MLA 12 and the lenticular lens 13.

Instead of the MLA, a light diffuser plate, for example, may be used. In consideration of the light utilization factor, it is advantageous to use the MLA, which controls the distribution of the luminous intensity of light.

The lens surface of the lenticular lens 13 is directed toward the light receiving surface 10 to face the lens surface of the MLA 12. It is preferable that the lenticular lens 13 is located away from the MLA 12 by at least the focal length of the lenses (microlenses) of the MLA 12. If the lenticular lens 13 and the MLA 12 have a distance therebetween that is shorter than the focal length of the microlenses, the effect of decreasing the number of speckles is reduced. By contrast, if the lenticular lens 13 and the MLA 12 have a distance therebetween that is longer than twice the focal length, an image is easily blurred. In consideration of these factors, it is preferable that the lenticular lens 13 and the MLA 12 have a distance d therebetween that is in the range of 0.5 f to 4 f, where f is the focal length of the microlens.

The lens surface of the lenticular lens 14 is directed toward the light emitting surface 11. In this manner, an “optical sheet” formed of a stack of two lenticular lenses 13 and 14 is formed on the side of the light emitting surface 11 of the transmission screen 2A. In the case where the optical sheet is located on the side of the light emitting surface 11, the divergent light beam has a generally rectangular cross-section. The divergent light beam forms, on the combiner 4, the irradiation region 5, which is generally rectangular in correspondence with the cross-sectional shape thereof.

With reference to FIG. 5(b), vectors each representing a shift direction between adjacent lenses will be described.

As shown in FIG. 5(b), regarding the MLA 12, vectors e1, e2 and e3 are defined as vectors each representing a shift direction between adjacent microlenses. Vector e1 is directed from the center of a microlens M1 toward the center of a microlens M2. The direction of vector e1 is a shift direction of the center of the microlens M2 on the basis of the center of the microlens M1. Similarly, vector e2 is directed from the center of the microlens M2 toward the center of a microlens M3. The direction of vector e2 is a shift direction of the center of the microlens M3 on the basis of the center of the microlens M2. Vector e3 is directed from the center of the microlens M3 toward the center of the microlens M1. The direction of vector e3 is a shift direction of the center of the microlens M1 on the basis of the center of the microlens M3. In this manner, the directions of the plurality of vectors (e1, e2 and e3), each of which represents a shift direction between the lenses, are different from each other.

As shown in FIG. 5(b), regarding the lenticular lenses and 14, vectors e4 and e5 are defined as vectors each representing a shift direction between adjacent hemicylindrical lenses. Vector e4 connects the centers of the adjacent hemicylindrical lenses. The direction of vector e4 matches the first array direction (X axis direction). Vector e5 connects the centers of the adjacent hemicylindrical lenses. The direction of vector e5 matches the second array direction (Z axis direction).

As described above, in the MLA 12 and the lenticular lenses 13 and 14, the directions of vectors e1, e2, e3, e4 and e5, which represent the shift directions between the lenses, are different from each other.

Speckles are mainly generated in the direction of such a vector representing a shift direction between lenses. In this embodiment, the shift directions between the lenses in each optical element may be determined so as to counteract each other regarding the generation of speckles. In this case, the generation of speckles is suppressed efficiently.

In this embodiment, the lenticular lens 14 located closest to the light emitting surface 11 of the transmission screen 2B mainly determines the distribution of the luminous intensity of the light beam. Therefore, the pitch, the radius of curvature or the central angle of adjacent lenses included in the lenticular lens 14 may be changed so that the aspect ratio of the shape of irradiation of the divergent light beam having a generally rectangular cross-section (shape of the irradiation region 5) is changed.

As a result, the number of speckles is decreased, and the light utilization factor is improved.

As long as the lenticular lenses 13 and 14 are located such that the first array direction and the second array direction cross each other, the first array direction of the lenticular lens 13 and the second array direction of the lenticular lens 14 may be as shown in FIG. 5(c), namely, may be opposite to those shown in FIG. 5(b).

The MLA 12 may be located closest to the light emitting surface 11 of the transmission screen 2B. Such a structure also provides substantially the same effect as that described above.

Now, with reference to FIG. 6, a transmission screen in modification 1 of this embodiment will be described. Components same as those of the transmission screen 2A or 2B will bear the same reference signs and the detailed descriptions thereof will be omitted.

FIG. 6(a) and FIG. 6(c) are each a schematic cross-sectional view showing a structure of a transmission screen 2C. FIG. 6(b) shows a shape of the MLA 12 as seen from the side of the light receiving surface 10 of the transmission screen 2C shown in FIG. 6(a) and a shape of the lenticular lens 21 as seen from the side of the light emitting surface 11 of the transmission screen 2C shown in FIG. 6(a).

As shown in FIG. 6(a), the transmission screen 2C includes the lenticular lens 21 having a stack structure and the MLA 12. The MLA 12 is located on the side of the light receiving surface 10 of the lenticular lens 21. The transmission screen 2C has a structure obtained as a result of adding the MLA 12 to the transmission screen 2A shown in FIG. 4(d). The MLA 12 is located on the side of the light receiving surface 10 of the lenticular lens 21. The lens surface of the MLA 12 is directed toward the light receiving surface 10, and the lens surface of the lenticular lens 21 is directed toward the light emitting surface 11.

FIG. 6(b) shows vectors e1, e2, e3, e4 and e5 each representing a shift direction between adjacent lenses. Vectors e4 and e5 are defined as vectors each representing a shift direction between the lenses in the lenticular lens 21. The directions of vectors e4 and e5 respectively match the X axis direction and the Y axis direction. In this modification also, in the MLA 12 and the lenticular lens 21, the directions of vectors e1, e2, e3, e4 and e5, each representing a shift direction between lenses, are different from each other.

The transmission screen 2C may also have a structure shown in FIG. 6(c), which is obtained as a result of adding the MLA 12 to the transmission screen 2 shown in FIG. 3(a), which includes the lenticular lenses 13 and 14 located such that the lens surfaces thereof face each other. The MLA 12 is located on the side of the light receiving surface 10.

The transmission screen in the modification shown in FIG. 6(a) or FIG. 6(c) decreases the number of speckles efficiently.

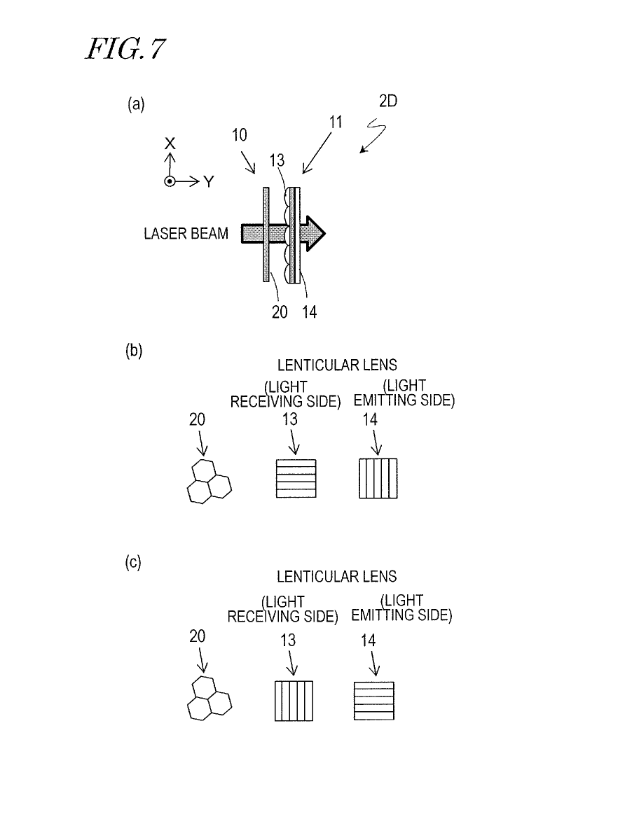

Now, with reference to FIG. 7 through FIG. 9, transmission screens in modifications 2 through 4 of this embodiment will be described. Components same as those of the transmission screen 2C will bear the same reference signs and the detailed descriptions thereof will be omitted.

With reference to FIG. 7, modification 2 will be described.

FIG. 7(a) is a schematic cross-sectional view showing a structure of a transmission screen 2D. FIG. 7(b) and FIG. 7(c) each show a shape of a fiber optical plate 20 as seen from the side of the light emitting surface 11 of the transmission screen 2D, a shape of the lenticular lens 13 as seen from the side of the light receiving surface 10 of the transmission screen 2D, and a shape of the lenticular lens 14 as seen from the side of the light emitting surface 11.

Unlike the transmission screen 2B, the transmission screen 2D includes the fiber optical plate 20 (hereinafter, referred to as an “FOP”) 20 located on the side of the light receiving surface 10 instead of the MLA 12.

The transmission screen 2D includes the FOP 20 and the lenticular lenses 13 and 14. The FOP 20 is formed of a plurality of hexagonal optical fibers arrayed in a hexagonal close-packed arrangement. In general, an FOP is formed of a plurality of optical fibers and is used as, for example, a waveguide path for an optical device.

The FOP 20 is located on the side of the light receiving surface 10 of the transmission screen 2D, and the lenticular lenses 13 and 14 are located on the side of the light emitting surface 11 of the transmission screen 2D such that the array directions of the respective lenses cross each other. It is preferable that the array directions of the respective lenses are perpendicular to each other from the point of view of providing a generally rectangular cross-section of a divergent light beam to effectively use the light.

The FOP 20 is located to face the light emitting surface 11 so as to condense display light from the video source 1 to form a real image between the FOP 20 and the lenticular lens 13. The lens surface of the lenticular lens 13 is directed toward the light receiving surface 10 to face the FOP 20. The lens surface of the lenticular lens 14 is directed toward the light emitting surface 11. Like in the transmission screen 2, an optical sheet formed of the lenticular lenses 13 and 14 is located on the side of the light emitting surface 11. From the light emitting surface 11, a divergent light beam having a generally rectangular cross-section is output.

The FOP 20 has a function of reducing coherence of a laser beam. As described above, in the case where, for example, a laser beam is used as a light source of the video source 1, speckles are easily generated. Use of the FOP 20 significantly suppresses the generation of speckles. Even in the case where the FOP 20 is used, a divergent light beam having a generally rectangular cross-section is output from the light emitting surface 11 of the transmission screen 2D, and the irradiation region 5 of the light is accommodated in the planar area of the combiner 4. This allows the irradiation region of the divergent light beam to be sufficiently restricted.

As a result, the light utilization factor is improved, and also the generation of speckles is significantly suppressed. Low power consumption and/or high luminance of the video image is realized.

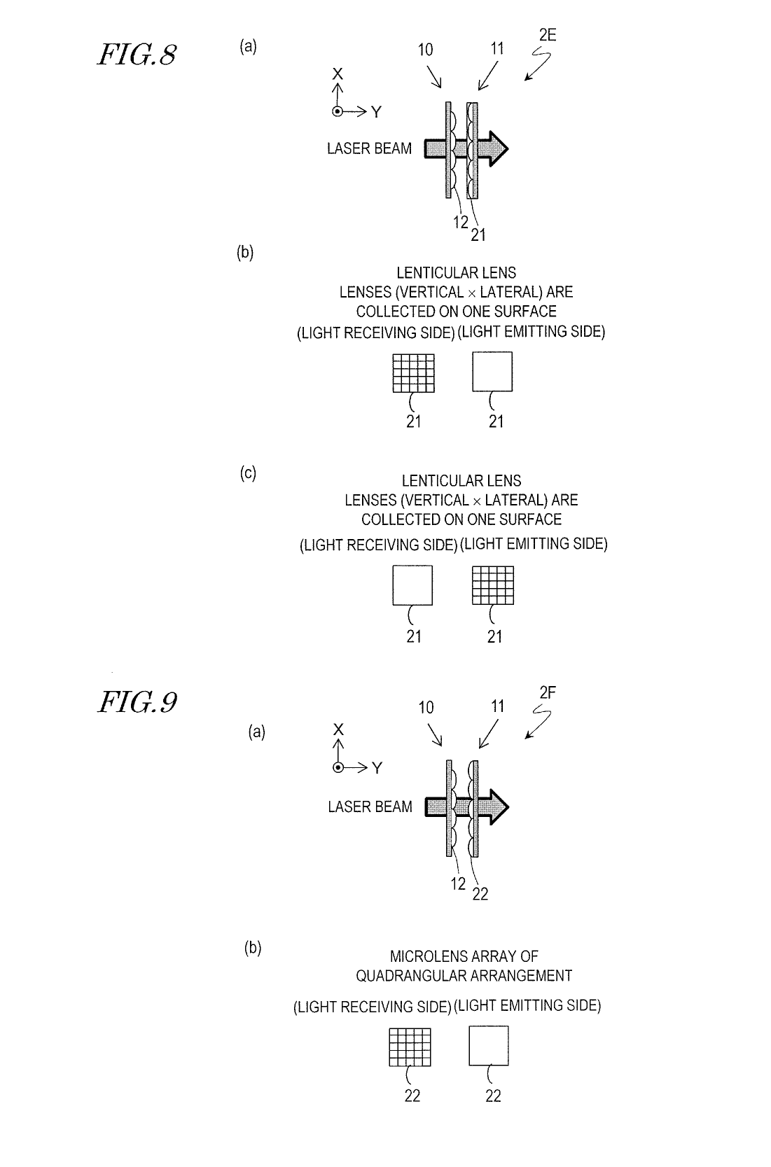

Now, with reference to FIG. 8, modification 3 will be described.

FIG. 8(a) is a schematic cross-sectional view showing a structure of a transmission screen 2E. FIG. 8(b) and FIG. 8(c) each show a shape of the lenticular lens 21 as seen from the side of the light emitting surface 11 and as seen from the side of the light receiving surface 10.

Unlike the transmission screen 2B, the transmission screen 2E includes two lenticular lenses located on the side of the light emitting surface 11 such that lens surfaces thereof are directed toward the light receiving surface 10. Components same as those of the transmission screen 2B will not be described in detail.

The transmission screen 2E includes the MLA 12 and the lenticular lens 21. The MLA 12 is located on the side of the light receiving surface 10 of the transmission screen 2E, and the lenticular lens 21 is located on the side of the light emitting surface 11 of the transmission screen 2E. The lens surface of the MLA 12 is directed toward the light emitting surface 11. As shown in FIG. 8(b), the two lenticular lenses are located such that the lens surfaces thereof are directed toward the light receiving surface 10 of the transmission screen 2E and such that the array directions thereof cross each other. Thus, the two lenticular lenses forming a stack are integrated together to form the lenticular lens 21. It is preferable that the array directions of the respective lenses are perpendicular to each other from the point of view of providing a generally rectangular cross-section of a divergent light beam to effectively use the light.

The MLA 12 condenses display light from the video source 1 to form a real image between the MLA 12 and the lenticular lens 21. The lens surface of the lenticular lens 21 is directed toward the light receiving surface 10. Like in the transmission screen 2B, an optical sheet formed of the two lenticular lenses (lenticular lens 21) is located on the side of the light emitting surface 11 of the transmission screen 2E. From the light emitting surface 11, a divergent light beam having a generally rectangular cross-section is output.

Alternatively, as shown in FIG. 8(c), the two lenticular lenses may be located such that the lens surfaces thereof are directed toward the light emitting surface 11 of the transmission screen 2E and such that the array directions thereof cross each other. In this case also, the two lenticular lenses forming a stack are integrated together to form the lenticular lens 21. It is preferable that the array directions of the respective lenses are perpendicular to each other from the point of view of providing a generally rectangular cross-section of a divergent light beam to effectively use the light.

In the example shown in FIG. 8(a), the MLA 12 is located on the side of the light receiving surface 10 of the transmission screen 2E. Alternatively, the FOP 20 may be located on the side of the light receiving surface 10 of the transmission screen 2E.

In the case where the lenticular lens 21 integrally formed is located on the side of the light emitting surface 11 of the transmission screen 2E as shown in FIG. 8(b) or FIG. 8(c), a divergent light beam having a generally rectangular cross-section is output from the light emitting surface 11 of the transmission screen 2E, and the irradiation region 5 of the light is accommodated in the planar area of the combiner 4. This allows the irradiation region of the divergent light beam to be sufficiently restricted to improve the light utilization factor. As a result, low power consumption and/or high luminance of the video image is realized.

Now, with reference to FIG. 9, modification 4 will be described.

FIG. 9(a) is a schematic cross-sectional view showing a structure of a transmission screen 2F. FIG. 9(b) shows a shape of a microlens array 22 of a quadrangular arrangement as seen from the side of the light emitting surface 11 and as seen from the side of the light receiving surface 10.

Unlike the transmission screen 2E, the transmission screen 2F includes the MLA 22 of a quadrangular arrangement is located on the side of the light emitting surface 11.

The transmission screen 2F includes the MLA 12 and the MLA 22. As described above, the MLA 12 includes a plurality of hexagonal lenses arrayed in a hexagonal close-packed arrangement, whereas the MLA 22 includes a plurality of quadrangular lenses arrayed in a quadrangular arrangement. The MLA 22 is a microlens array of a so-called quadrangular arrangement. The lenses in the MLA 22 do not need to be square, and may be, for example, box or circular. It is preferable that the lenses are rectangular from the point of view of improving the light utilization factor.

The MLA 12 is located on the side of the light receiving surface 10 of the transmission screen 2F, and the MLA 22 is located on the side of the light emitting surface 11 of the transmission screen 2F. The lens surface of the MLA 12 is directed toward the light emitting surface 11, and a lens surface of the MLA 22 is directed toward the light receiving surface 10. From the light emitting surface 11, a divergent light beam having a generally rectangular cross-section is output.

In the example shown in FIG. 9(a), the MLA 12 is located on the side of the light receiving surface 10. Alternatively, the FOP 20 may be located on the side of the light receiving surface 10.

As described above, also in the case where the MLA 22 is used, a divergent light beam having a generally rectangular cross-section is output from the light emitting surface 11 of the transmission screen 2F, and the irradiation region 5 of the light is accommodated in the planar area of the combiner 4. This allows the irradiation region of the divergent light beam to be sufficiently restricted to improve the light utilization factor. As a result, low power consumption and/or high luminance of the video image is realized. In addition, as in this embodiment, the number of speckles is decreased efficiently.

In the case where the two lenticular lenses are located on the side of the light emitting surface 11 of the transmission screen, the in-plane luminance of the irradiation region 5 is easily uniformized. By contrast, in the case where the MLA 22 is located on the side of the light emitting surface 11, it is difficult to provide a uniform in-plane luminance of the irradiation region 5. However, the MLA 22 may be realized by any general-purpose component selectable from a wide range and thus it is advantageous to use the MLA 22 in terms of the production cost. The designing specifications of the transmission screen may be determined in consideration of the balance of the performance and the cost.

### Embodiment 3

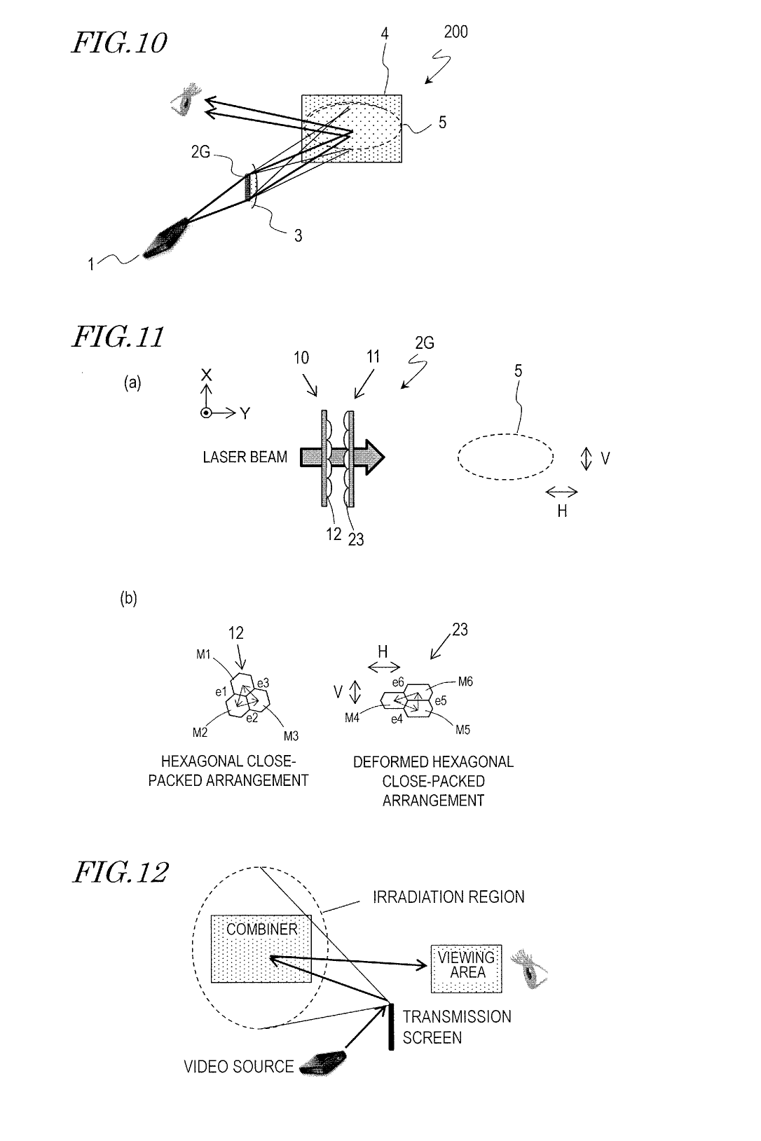

With reference to FIG. 10 and FIG. 11, a structure and a function of a head display 200 in this embodiment will be described.

The headup display 200 outputs a divergent light beam having a generally elliptical cross-section from a transmission screen 2G toward the combiner 4. The divergent light beam forms, on the combiner 4, the irradiation region 5, which is generally elliptical in correspondence with the cross-sectional shape thereof.

FIG. 10 is a schematic view of the headup display 100 in this embodiment.

Unlike the headup display 100, the headup display 200 outputs a divergent light beam having a generally elliptical cross-section from the transmission screen 2G toward the combiner 4. Specifically, the structure of the transmission screen is different. Components same as those of the headup display 100 will not be described in detail.

The headup display 200 includes the video source 1, the transmission screen 2G, the field lens 3, and the combiner 4. The headup display 200 does not need to include the field lens 3.

FIG. 11(a) is a schematic cross-sectional view showing a structure of the transmission screen 2G. FIG. 11(b) shows a shape of the MLA 12 as seen from the side of the light emitting surface 11 of the transmission screen 2G and a shape of an MLA 23 of a deformed hexagonal close-packed arrangement as seen from the side of the light receiving surface 10 of the transmission screen 2G.

The transmission screen 2G includes the MLA 12 and the MLA 23. The MLA 12 is located on the side of the light receiving surface 10 of the transmission screen 2G, and the MLA 23 is located on the side of the light emitting surface 11 of the transmission screen 2G. The lens surface of the MLA 12 is directed toward the light emitting surface 11, and a lens surface of the MLA 23 is directed toward the light receiving surface 10.

In FIG. 11(a), direction H (first direction) is a direction of a longer axis of the irradiation region 5, which is generally elliptical, and direction V (direction perpendicular to the first direction) is a direction of a shorter axis of the irradiation region 5. The MLA 23 includes microlenses that are arrayed such that at least one of sides that form the profile of each of the microlenses and a side parallel to the one side are parallel to direction H or direction V.

In the example shown in FIG. 11(b), the microlenses are arrayed such that two sides of each microlens are parallel to direction H. The microlenses in the MLA 23 each have a hexagonal shape that is compressed or extended in direction H and/or direction V. An arrangement of microlenses having such a shape in a hexagonal close-packed manner is referred to as a “deformed hexagonal close-packed arrangement”. The lenses in the MLA 23 do not need to be hexagonal, and may be, for example, circular. It is preferable that the lenses in the MLA 23 are hexagonal from the point of view of improving the light utilization factor.

FIG. 11(b) shows the microlenses in the MLA 23 that are extended in direction H and compressed in direction V. The direction of the extended side matches the direction of the longer axis of the irradiation region 5, which is generally elliptical. The direction of the compressed side matches the direction of the shorter axis of the irradiation region 5. With such an arrangement, a divergent light beam is output from the light emitting surface 11 of the transmission screen 2G so as to have a generally elliptical cross-section.

FIG. 11(b) shows vectors e1, e2, e3, e4, e5 and e6 each representing a shift direction between adjacent lenses. Regarding the MLA 23, vectors e4, e5 and e6 are defined as vectors each representing a shift direction between adjacent lenses. Vector e4 is directed from the center of a microlens M4 toward the center of a microlens M5. The direction of vector e4 is a shift direction of the center of the microlens M5 on the basis of the center of the microlens M4. Vectors e5 and e6 are defined similarly.

In this embodiment also, the directions of vectors e1, e2, e3, e4, e5 and e6, each representing a shaft direction between lenses in the MLA 22 and the MLA 23, are different from each other.

In the above-described manner, the ratio of the lengths in the longer axis direction and the shorter axis direction of the irradiation region 5 of the divergent light beam may be changed in accordance with the ratio of compression or extension of the shape of the microlenses so as to change the cross-sectional shape of the divergent light beam. This allows the irradiation region of the divergent light beam to be sufficiently restricted to improve the light utilization factor. As a result, low power consumption and/or high luminance of the video image is realized. As in embodiment 2, the number of speckles is decreased efficiently.

### INDUSTRIAL APPLICABILITY

A transmission screen according to the present invention is usable for HUDs, head mounted displays, other virtual image displays and the like.

### REFERENCE SIGNS LIST

1 Video source
2, 2A, 2B, 2C, 2D, 2E, 2F, 2G Transmission screen
3 Field lens
4 Combiner
5 Irradiation region
10 Light receiving surface
11 Light emitting surface
12, 22, 23 Microlens array
13, 14, 21 Lenticular lens
20 Fiber optical plate
100, 200 Headup display

1. A transmission screen usable for a headup display, the transmission screen comprising:
at least two optical elements condensing or diverging a light beam anisotropically;
wherein the at least two optical elements include:
a light receiving surface receiving display light; and
a light emitting surface emitting a divergent light beam toward a combiner.

2. The transmission screen according to claim 1, wherein the at least two optical elements condense or diverge the light beam in a monoaxial direction or biaxial directions.

3. The transmission screen according to claim 2, wherein the at least two optical elements include a lenticular lens.

4. The transmission screen according to claim 3, wherein:
the at least two optical elements include a first lenticular lens including a plurality of hemicylindrical lenses arranged in a first direction and a second lenticular lens including a plurality of hemicylindrical lenses arranged in a second direction crossing the first direction; and
a lens surface of the first lenticular lens is directed toward the light emitting surface, and a lens surface of the second lenticular lens is directed toward the light receiving surface to face the lens surface of the first lenticular lens.

5. The transmission screen according to claim 3, wherein:
the at least two optical elements include a first lenticular lens including a plurality of hemicylindrical lenses arranged in a first direction and a second lenticular lens including a plurality of hemicylindrical lenses arranged in a second direction crossing the first direction; and
a lens surface of the first lenticular lens and a lens surface of the second lenticular lens are directed in the same direction as each other toward the light receiving surface or the light emitting surface.

6. The transmission screen according to claim 4, wherein the first direction and the second direction are perpendicular to each other.

7. The transmission screen according to claim 4, wherein:
the first lenticular lens is located on the side of the light receiving surface of the second lenticular lens; and
the lens surface of the first lenticular lens and the lens surface of the second lenticular lens are convexed, and a focal length of the first lenticular lens is longer than a focal length of the second lenticular lens.

8. The transmission screen according to claim 4, wherein:
the first lenticular lens is located on the side of the light receiving surface of the second lenticular lens; and
the lens surface of the first lenticular lens and the lens surface of the second lenticular lens are concaved, and a focal length of the first lenticular lens is shorter than a focal length of the second lenticular lens.

9. The transmission screen according to claim 5, wherein the first lenticular lens and the second lenticular lens are integrally formed.

10. The transmission screen according to claim 3, wherein the at least two optical elements further include a microlens array including an array of a plurality of microlenses.

11. The transmission screen according to claim 9, wherein:
the at least two optical elements further include a microlens array including an array of a plurality of microlenses; and
the microlens array is located on the side of the light receiving surfaces of the first and second lenticular lenses.

12. The transmission screen according to claim 4, wherein:
the at least two optical elements further include a microlens array including an array of a plurality of microlenses; and
the microlens array is located on the side of the light receiving surface of the first lenticular lens.

13. The transmission screen according to claim 4, wherein:
the at least two optical elements further include a microlens array including an array of a plurality of microlenses; and
the microlens array is located on the side of the light emitting surface of the second lenticular lens.

14. The transmission screen according to claim 10, wherein directions of a plurality of vectors each representing a shift direction between adjacent microlenses in the microlens array are different from each other.

15. The transmission screen according to claim 14, wherein each of the directions of the plurality of vectors and a direction of a vector representing a shift direction between adjacent lenses in the lenticular lens are different from each other.

16. The transmission screen according to claim 1, wherein the at least two optical elements include any one of a light diffuser plate, a fiber optical plate in which a plurality of optical fibers are arranged, a volume or embossed hologram element, and a diffraction grating.

17. A headup display, comprising:
a video source outputting display light;
the transmission screen according to claim 1; and
a combiner.

18. The headup display according to claim 17, wherein the video source is a laser light source.
